(19) United States
(12) Patent Application Publication
(10) Pub. No.: US 2025/0023308 A1
(43) Pub. Date: Jan. 16, 2025

(54) ELECTRICAL CONNECTOR

(71) Applicant: LOTES CO., LTD., Keelung (TW)

(72) Inventor: Lun Cai, Keelung (TW)

(21) Appl. No.: 18/760,164

(22) Filed: Jul. 1, 2024

(30) Foreign Application Priority Data
Jul. 10, 2023 (CN) 202310843592.2

(51) Int. Cl. H01R 33/76

(52) U.S. Cl. CPC H01R 33/7628; H01R 33/7664; H01R 33/7685

(57) ABSTRACT

An electrical connector includes an insulating body having a bottom wall and a first terminal and a second terminal accommodated in the insulating body along a vertical direction. The bottom wall has a first abutting portion. The first terminal has a first abutting arm, and the second terminal has a second abutting arm. The first abutting portion is located between the first abutting arm and the second abutting arm. The first abutting arm and the first abutting surface clamp a first solder, and the first abutting arm exerts a first acting force directed toward the first abutting portion on the first solder. The second abutting arm and the second abutting surface clamp a second solder, and the second abutting arm exerts a second acting force directed toward the first abutting portion on the second solder.

### CROSS-REFERENCE TO RELATED PATENT APPLICATION

This non-provisional application claims priority to and the benefit of, pursuant to 35 U.S.C. § 119 (a), patent application Serial No. CN202310843592.2 filed in China on Jul. 10, 2023. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector with terminals clamping solders.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Chinese Patent Application No. CN201720041445.3 discloses an electrical connector, which includes an insulating body and a plurality of terminals. The insulating body includes a plurality of accommodating holes accommodating the terminals. Each terminal is provided with a connecting portion, and the insulating body is provided with a protruding block. The protruding block and the connecting portion are located respectively at two opposite sides of a solder ball, and the protruding block and the connecting portion collectively clamp the solder ball.

However, in the electrical connector, the abutting directions of the connecting portions of all terminals to the solder balls are identical, and each protruding block only abuts against a corresponding solder ball. Due to the protruding blocks occupying the space of the electrical connector, it inevitably prevents the quantity of the terminals in the electrical connector from further increasing, which does not match with the trend of densification of the electrical connector. In addition, the abutting directions of the connecting portions of all terminals to the solder balls are identical, such that the abutting forces exerted by all terminals on the solder balls are concentrated in one direction, and the forces exerted by the terminals on the plastic for maintaining balance are also concentrated in one direction, which easily results in adverse effects such as warping of the insulating body, thus affecting the soldering of the terminals.

Therefore, a heretofore unaddressed need to design a new electrical connector exists in the art to address the aforementioned deficiencies and inadequacies.

### SUMMARY

The present invention is directed to an electrical connector, in which the quantity of the abutting portion is reduced by using one abutting portion to abut against two solders, thereby providing more terminals. Further, the abutting directions of the abutting arms of two adjacent terminals are opposite to each other, and the abutting forces of them to the solders may be balanced on the abutting portion, thereby preventing the forces exerted by all terminals on the insulating body in the horizontal direction from being identical.

To achieve the foregoing objective, the present invention adopts the following technical solutions.

An electrical connector includes: an insulating body, comprising a bottom wall, wherein the bottom wall has a first abutting portion, and the first abutting portion is provided with a first abutting region and a second abutting region opposite to each other in a horizontal direction; a first terminal, accommodated in the insulating body along a vertical direction, wherein the first terminal has a first abutting arm; and a second terminal, accommodated in the insulating body along the vertical direction and adjacent to the first terminal, wherein the second terminal has a second abutting arm. The first abutting portion is located between the first abutting arm and the second abutting arm, the first abutting arm and the first abutting region clamp a first solder, the first abutting arm exerts a first acting force directed toward the first abutting portion on the first solder, the second abutting arm and the second abutting region clamp a second solder, and the second abutting arm exerts a second acting force directed toward the first abutting portion on the second solder.

In certain embodiments, the first terminal has a first body portion and a first extending portion formed by extending downward from the first body portion, the first extending portion passes beyond the bottom wall, the first extending portion has a first side edge close toward the second terminal and a second side edge away from the second terminal, the first abutting arm comprises a first elastic abutting portion and a second elastic abutting portion bending and extending from the first elastic abutting portion, the first elastic abutting portion bends and extends from the second side edge, and the first extending portion, the first elastic abutting portion, the second elastic abutting portion and the first abutting region collectively abut against the first solder.

In certain embodiments, the second elastic abutting portion extends toward a direction close toward the first abutting portion from the first elastic abutting portion, a tail end of the second elastic abutting portion has a narrow portion, the narrow portion inclines toward the first extending portion, in the vertical direction, a width of the narrow portion is less than a width of the first elastic abutting portion, and when mounting the first solder, the narrow portion abuts against and pierces the first solder.

In certain embodiments, the second terminal has a second body portion and a second extending portion formed by extending downward from the second body portion, the second extending portion passes beyond the bottom wall, the second extending portion has a third side edge close toward the first terminal and a fourth side edge away from the first terminal, the second abutting arm comprises a third elastic abutting portion and a fourth elastic abutting portion bending and extending from the third elastic abutting portion, the third elastic abutting portion bends and extends from the fourth side edge, the second extending portion, the third elastic abutting portion, the fourth elastic abutting portion and the second abutting region collectively abut against the second solder, the second elastic abutting portion and the fourth elastic abutting portion extend toward each other, and a distance between a tail end of the second elastic abutting portion and a tail end of the fourth elastic abutting portion is shorter than a distance between the fourth side edge and the second side edge.

In certain embodiments, the first terminal has a first body portion and a first extending portion formed by extending downward from the first body portion, the first abutting arm bends and extends from a side of the first extending portion, and a bottom edge of the first extending portion is provided with at least one notch.

In certain embodiments, the first terminal has a first body portion and a first extending portion formed by extending downward from the first body portion, the first abutting arm bends and extends from the first extending portion, the first terminal further has a groove, the groove is located between the first body portion and the first abutting arm, and the groove separates the first body portion and the first abutting arm in the vertical direction.

In certain embodiments, the electrical connector further includes a third terminal. The third terminal has a soldering arm, the insulating body has a second abutting portion, the soldering arm and the second abutting portion clamp a third solder, the soldering arm exerts a third acting force directed toward the second abutting portion on the third solder, directions of lateral components of the third acting force and the second acting force in a left-right direction are opposite to each other, the first terminal, the second terminal and the third terminal are arranged in a row in the left-right direction, and the soldering arm and the second abutting arm are adjacent to each other in the left-right direction.

In certain embodiments, the first terminal has a first body portion and a first extending portion formed by extending downward from the first body portion, the first extending portion has a bending portion formed by bending backward and extending downward from the first body portion and a straight portion extending downward from the bending portion, the bending portion abuts against the first solder and stops the first solder from moving upward, the first abutting arm bends forward and extends from the straight portion, and the straight portion abuts against the first solder.

In certain embodiments, the first terminal has a first body portion and a first extending portion formed by extending downward from the first body portion, the first abutting arm bends and extends from the first extending portion, the first body portion comprises a first protruding portion extending toward the second terminal, and the first protruding portion abuts against the insulating body; the second terminal has a second body portion and a second extending portion formed by extending downward from the second body portion, the second abutting arm bends and extends from the second extending portion, the second body portion comprises a second protruding portion extending toward the first terminal, and the second protruding portion abuts against the insulating body; and a distance between the first extending portion and the second extending portion is greater than a distance between the first protruding portion and the second protruding portion.

An electrical connector includes: an insulating body, comprising a bottom wall and a plurality of accommodating slots running through the bottom wall along a vertical direction, wherein the bottom wall is provided with an abutting portion, and the abutting portion is provided with a first abutting region and a second abutting region opposite to each other in a horizontal direction; and a plurality of ground terminals, accommodated in the accommodating slots, wherein each of the ground terminals has a first soldering arm and a second soldering arm opposite to the first soldering arm. The abutting portion is located between the first soldering arm and the second soldering arm, the first soldering arm and the first abutting region clamp a first solder, and the second soldering arm and the second abutting region clamp a second solder.

In certain embodiments, each of the ground terminals has a body portion accommodated in a corresponding one of the accommodating slots and an extending portion extending downward from the body portion, the extending portion passes beyond the bottom wall, the first soldering arm comprises a first elastic soldering portion and a second elastic soldering portion bending and extending from the first elastic soldering portion, the first elastic soldering portion bends and extends from one side edge of the extending portion, the extending portion, the first elastic soldering portion, the second elastic soldering portion and the first abutting region collectively abut against the first solder, the second soldering arm comprises a third elastic soldering portion and a fourth elastic soldering portion bending and extending from the third elastic soldering portion, the third elastic soldering portion bends and extends from another side edge of the extending portion, the second elastic soldering portion and the fourth elastic soldering portion extend toward each other, and the extending portion, the third elastic soldering portion, the fourth elastic soldering portion and the second abutting region collectively abut against the second solder.

An electrical connector includes: an insulating body, comprising a plurality of accommodating slots running through the insulating body along a vertical direction; and a plurality of signal terminals, wherein each of the signal terminals comprises a body portion accommodated in a corresponding one of the accommodating slots and an extending portion formed by extending downward from the body portion, an abutting arm bends and extends from only one side of the extending portion along a horizontal direction, the abutting arm embraces a solder, and a plate surface of the abutting arm is in contact with the solder.

In certain embodiments, a projection of the solder along the vertical direction has more than one-half of a region being enclosed by the abutting arm.

In certain embodiments, the insulating body comprises a plurality of abutting portions, and two opposite sides of each of the abutting portions abut against two solders.

In certain embodiments, one of a left side and a right side of the body portion has a short protruding portion and the other of the left side and the right side of the body portion has a long protruding portion, the short protruding portion and the long protruding portion both abut against a slot wall of the corresponding one of the accommodating slots, along a left-right direction, a length of the long protruding portion protruding from the extending portion is greater than a length of the short protruding portion protruding from the extending portion, the long protruding portion and the abutting arm are located at a same side of the extending portion, and a groove exists between the long protruding portion and the abutting arm.

In certain embodiments, two adjacent ones of the signal terminals form a differential signal pair, one of a left side and a right side of the body portion has a short protruding portion and the other of the left side and the right side of the body portion has a long protruding portion, the short protruding portion and the long protruding portion both abut against a slot wall of the corresponding one of the accommodating slots, along a left-right direction, a length of the long protruding portion protruding from the extending portion is greater than a length of the short protruding portion protruding from the extending portion, and short protruding portions of two signal terminals of the differential signal pair protrude toward each other.

Compared to the related art, the electrical connector according to certain embodiments of the present invention has the following beneficial effects:

One abutting portion may abut against two solders, which may reduce the provision of the abutting portion, and provide more terminals in a limited space, thus facilitating the densification trend of the connector.

The first abutting arm may exert a first acting force directed toward the abutting portion on the first solder, and the second abutting arm may exert a second acting force directed toward the abutting portion on the second solder. Because the abutting portion is located between the first abutting arm and the second abutting arm, the first acting force and the second acting force will eventually act on the abutting portion, and the lateral components of them along the left-right direction will be opposite to each other, thereby balancing the lateral components of the two forces at the location of the abutting portion, thus preventing the directions of the forces from being identical, allowing the insulating body not to easily warp, such that the soldering of the first terminal and the second terminal are more stable.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector according to certain embodiments of the present invention.

FIG. 2 is a bottom view of an electrical connector according to certain embodiments of the present invention.

FIG. 3 is an enlarged schematic view of a portion A of FIG. 2.

FIG. 4 is a sectional view of FIG. 2 along a line B-B.

FIG. 5 is a perspective schematic view of a first terminal and a second terminal according to certain embodiments of the present invention.

FIG. 6 is side view of the first terminal according to certain embodiments of the present invention.

FIG. 7 is a perspective schematic view of a third terminal according to certain embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

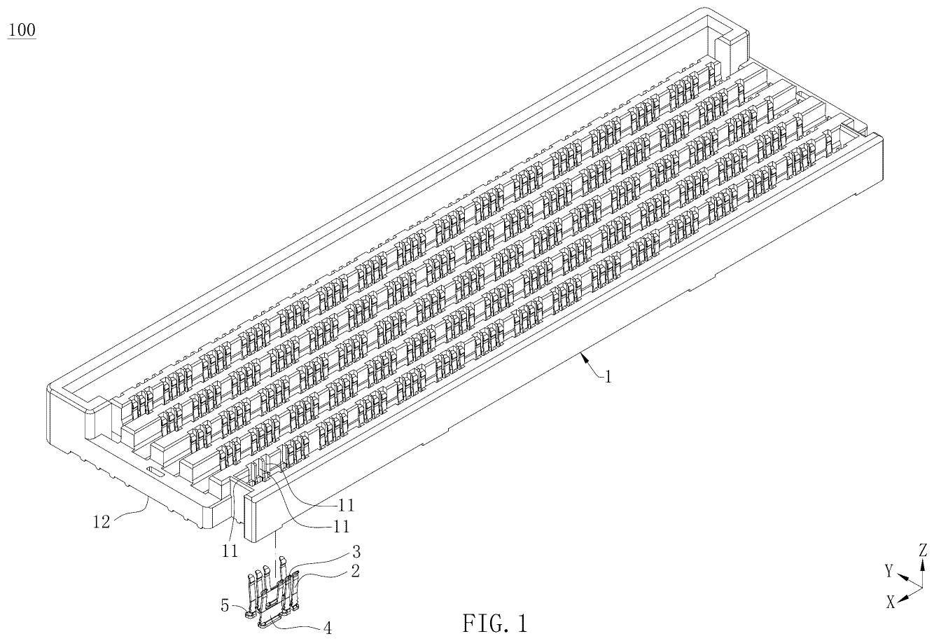

The description will be made as to the embodiments of the present invention in conjunction with the accompanying drawings in FIGS. 1-7. In accordance with the purposes of this invention, as embodied and broadly described herein, this invention, in one aspect, relates to an electrical connector.

In the electrical connector 100 according to certain embodiments of the present invention, a left-right direction is defined as the X-axis, where a leftward direction is a positive direction of the X-axis; a front-rear direction is defined as the Y-axis, where a forward direction is a positive direction of the Y-axis; and a vertical direction is defined as the Z-axis, where an upward direction is a positive direction of the Z-axis. A horizontal direction and the vertical direction are perpendicular to each other.

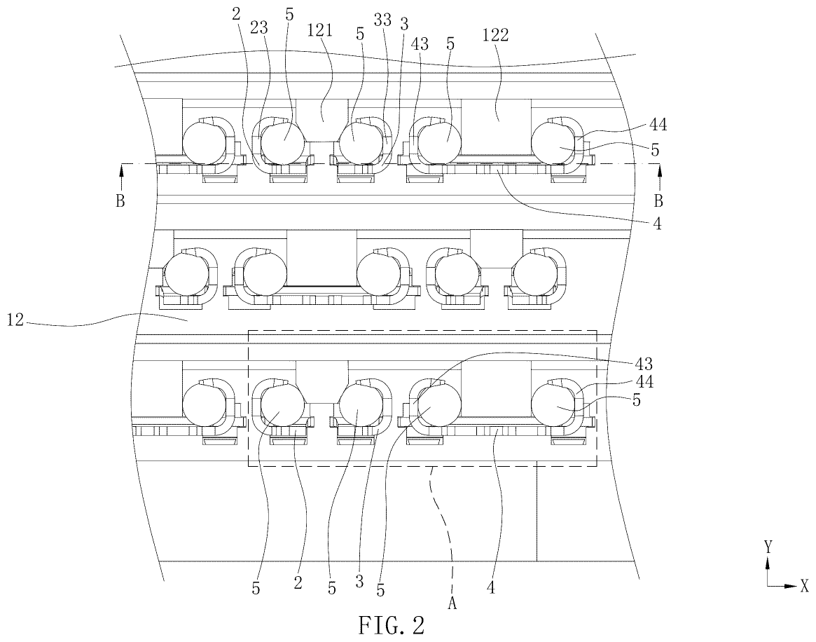

As shown in FIG. 1 and FIG. 2, the present invention provides an electrical connector, which includes an insulating body 1, a first terminal 2, a second terminal 3, a third terminal 4 and solders fixedly provided in the terminals. Specifically, the first terminal 2 and the second terminal 3 are signal terminals, and the third terminal 4 is a ground terminal. In other embodiments, the first terminal 2 and/or the second terminal 3 may be ground terminals, and the third terminal 4 may be a signal terminal.

The insulating body 1 includes a bottom wall 12 and a plurality of accommodating slots 11 running through the bottom wall 12 along the vertical direction. The accommodating slots 11 includes a first accommodating slot, a second accommodating slot and a third accommodating slot, the first terminal 2 is accommodated in the first accommodating slot, the second terminal 3 is accommodated in the second accommodating slot, the third terminal 4 is accommodated in the third accommodating slot, and the bottom wall is provided with a plurality of abutting portions protruding downward. Specifically, the abutting portions include a first abutting portion 121 and a second abutting portion 122, and the solders include a first solder 51, a second solder 52, a third solder 53 and a fourth solder 54. The first abutting portion 121 is located between the first solder 51 and the second solder 52, and the second abutting portion 122 is located between the third solder 53 and the fourth solder 54.

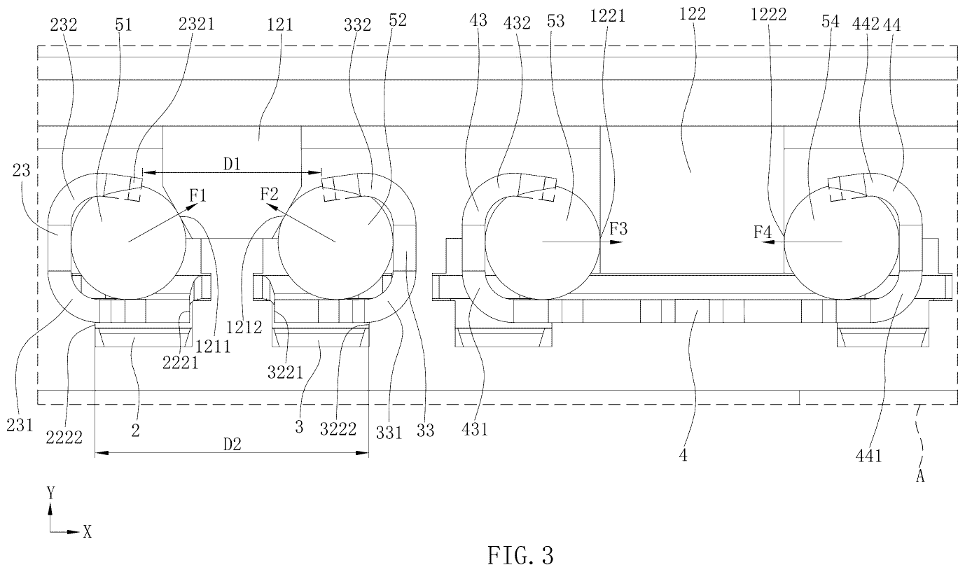

As shown in FIG. 2 and FIG. 3, the first terminal 2 has a first abutting arm 23, and the second terminal 3 has a second abutting arm 33. The first abutting portion 121 is located between the first abutting arm 23 and the second abutting arm 33, and the first abutting portion 121 is provided with a first abutting region 1211 and a second abutting region 1212 opposite to each other in the horizontal direction. In the present embodiment, the first abutting region 1211 and the second abutting region 1212 are two surfaces of the first abutting portion 121. In other embodiments, the first abutting region 1211 and the second abutting region 1212 may be two vertices of the first abutting portion 121. The first abutting arm 23 and the first abutting region 1211 clamp a first solder 51. The first abutting arm 23 exerts a first acting force F1 directed toward the first abutting portion 121 on the first solder 51, and the first acting force F1 has a lateral component in a leftward direction. The second abutting arm 33 and the second abutting region 1212 clamp a second solder 52. The second abutting arm 33 exerts a second acting force F2 directed toward the first abutting portion 121 on the second solder 52, and the second acting force F2 has a lateral component in a rightward direction. The first solder 51, the second solder 52 and the third solder 53 are solder balls. In other embodiments, the solders may be any material manufactured in any fixed shape that may solder the terminals onto a circuit board.

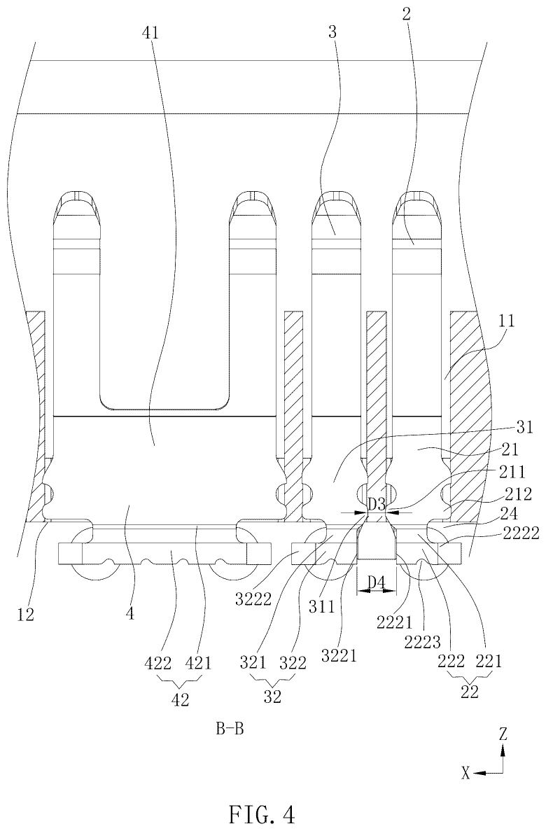

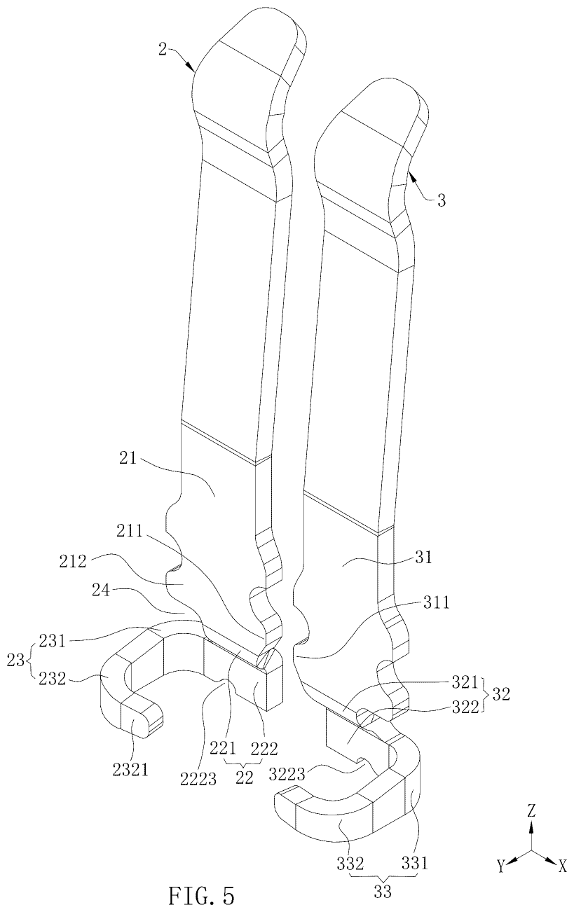

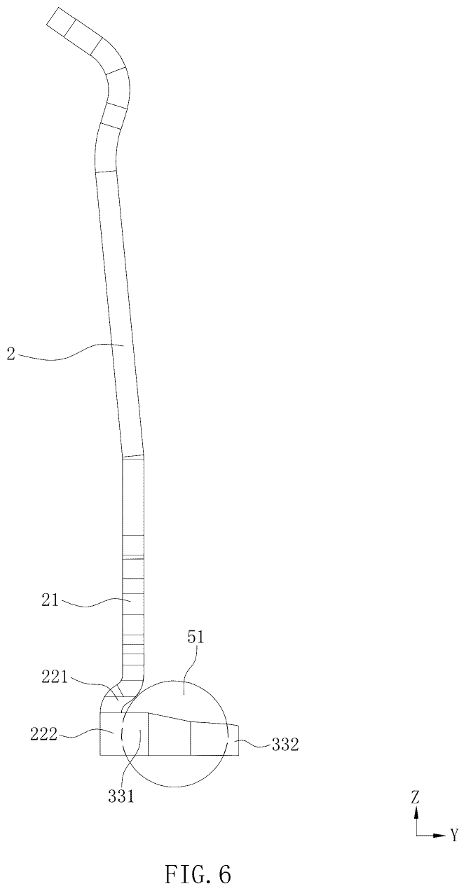

As shown in FIG. 4, FIG. 5 and FIG. 6, the first terminal 2 has a first body portion 21 accommodated in a corresponding accommodating slot 11 and a first extending portion 22 formed by extending downward from the first body portion 21. The first body portion 21 includes a first protruding portion 211 extending toward the second terminal 3 and another protruding portion extending away from the second terminal 3. Specifically, the first protruding portion 211 is a short protruding portion, and the other protruding portion is a long protruding portion 212. Along the left-right direction, a length of the long protruding portion 212 protruding from the first extending portion 22 is greater than a length of the short protruding portion 211 protruding from the first extending portion 22. The long protruding portion 212 and the first abutting arm 23 are located at a same side of the first extending portion 22, and the first protruding portion 211 and the long protruding portion 212 abut against a slot wall of the corresponding accommodating slot 11, such that the first body portion 21 is fixed in the corresponding accommodating slot 11. The first extending portion 22 passes beyond the bottom wall 12. The first extending portion 22 has a first bending portion 221 bending backward and a first straight portion 222 extending downward from the first bending portion 221. The first bending portion 221 abuts against the first solder 51 and stops the first solder 51 from moving upward.

The first straight portion 222 has a first side edge 2221 close toward the second terminal 3 and a second side edge 2222 away from the second terminal 3. The first abutting arm 23 includes a first elastic abutting portion 231 and a second elastic abutting portion 232 bending and extending from the first elastic abutting portion 231. The first clastic abutting portion 231 bends and extends from the second side edge 2222. The first solder 51 is located in a space enclosed by the first straight portion 222, the first elastic abutting portion 231, the second elastic abutting portion 232 and the first abutting region 1211, and the first straight portion 222, the first elastic abutting portion 231, the second clastic abutting portion 232 and the first abutting region 1211 collectively abut against the first solder 51. A bottom portion of the first straight portion 222 is provided with a notch 2223 at a location close to the first solder 51, and when soldering, the notch 2223 may absorb additional solder to prevent the solder from spreading. The first terminal 2 has a groove 24 at a location of the first bending portion 221. The groove 24 is located between the long protruding portion 212 and the first abutting arm 231, and the groove 24 separates the first body portion 21 and the first abutting arm 231 in the vertical direction. With the existence of the groove 24, a width of the first bending portion 221 in the left-right direction is less than a width of the first straight portion 222 in the left-right direction. In other words, in the left-right direction, the second side edge 2222 passes beyond the first bending portion 221. During elastic deformation, the first abutting arm 23 may utilize the elasticity of a portion of the first straight portion 222 to enhance its abutting force on the first solder 51. Meanwhile, the groove 24 may absorb the solder climbing upward, thus preventing the solder from spreading upward to the first body portion 21.

A tail end of the second elastic abutting portion 232 has a narrow portion 2321. The narrow portion 2321 inclines toward the first extending portion 22. A width of the narrow portion 2321 in the vertical direction is less than a width of the first elastic abutting portion 231 in the vertical direction. When mounting the first solder 51, the narrow portion 2321 abuts against the first solder 51 and may and pierce an oxidation layer on the surface of the first solder 51, which is convenient for subsequent soldering.

The second terminal 3 has a second body portion 31 accommodated in a corresponding accommodating slot 11 and a second extending portion 32 formed by extending downward from the second body portion 31. The second body portion 31 includes a second protruding portion 311 extending toward the first terminal 2, and the second protruding portion 311 abuts against a slot wall of the corresponding accommodating slot 11, such that the second body portion 31 is fixed in the corresponding accommodating slot 11. The second extending portion 32 passes beyond the bottom wall 12. The second extending portion 32 has a second bending portion 321 bending backward and a second straight portion 322 extending downward from the second bending portion 321. The second bending portion 321 is located above the second solder 52 and abuts against the second solder 52.

The second straight portion 322 has a third side edge 3221 close toward the first terminal 2 and a fourth side edge 3222 away from the first terminal 2. The second abutting arm 33 includes a third elastic abutting portion 331 and a fourth elastic abutting portion 332 bending and extending from the third elastic abutting portion 331. The third elastic abutting portion 331 bends and extends from the fourth side edge 3222. The second solder 52 is located in a space enclosed by the second straight portion 322, the third elastic abutting portion 331, the fourth elastic abutting portion 332 and the second abutting region 1212, and the second straight portion 322, the third elastic abutting portion 331, the fourth elastic abutting portion 332 and the second abutting region 1212 collectively abut against the second solder 52. A bottom portion of the second straight portion 322 is provided with a notch 3223 at a location close to the second solder 52, and when soldering, the notch 3223 may absorb additional solder to prevent the solder from spreading.

As shown in FIG. 3, the second elastic abutting portion 232 and the fourth elastic abutting portion 332 extend toward each other, and a distance D1 between a tail end of the second elastic abutting portion 232 and a tail end of the fourth elastic abutting portion 332 is shorter than a distance D2 between the fourth side edge 3222 and the second side edge 2222, such that a projection of the second elastic abutting portion 232 in the front-rear direction partially overlaps with the first extending portion 22, and a projection of the fourth elastic abutting portion 332 in the front-rear direction partially overlaps with the second extending portion 32.

As shown in FIG. 4, in the process of the first bending portion 221 and the second bending portion 321 extending downward, the distance between the two gradually increases. At any location, a distance D4 between the first extending portion 22 and the second extending portion 32 is greater than a distance D3 between the first protruding portion 211 and the second protruding portion 311.

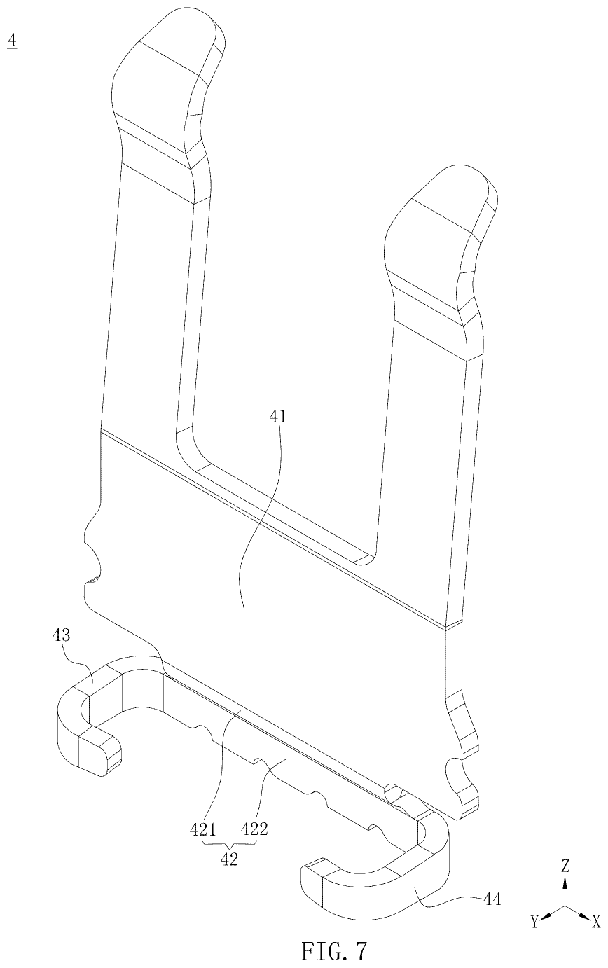

As shown in FIG. 3, FIG. 4 and FIG. 7, the third terminal 4 has a third body portion 41 accommodated in a corresponding accommodating slot 11 and a third extending portion 42 formed by extending downward from the third body portion 41. The third extending portion 42 passes beyond the bottom wall 12. The third extending portion 42 has a third bending portion 421 bending backward and a third straight portion 422 extending downward from the third bending portion 421. A first soldering arm 43 and a second soldering arm 44 respectively extend from a left side and a right side of the third straight portion 422. The second abutting portion 122 is located between the first soldering arm 43 and the second soldering arm 44. The second abutting portion 122 is provided with a third abutting region 1221 and a fourth abutting region 1222 opposite to each other in the horizontal direction. The first soldering arm 43 and the third abutting region 1221 clamp a third solder 53, and the first soldering arm 43 exerts a third acting force F3 directed toward the second abutting portion 122 on the third solder 53. The second soldering arm 44 and the fourth abutting region 1222 clamp a fourth solder 54, and the second soldering arm 44 exerts a fourth acting force F4 directed toward the second abutting portion 122 on the fourth solder 54.

The first soldering arm 43 includes a first elastic soldering portion 431 and a second elastic soldering portion 432 bending and extending from the first elastic soldering portion 431. The first elastic soldering portion 431 bends and extends from one side edge of the third extending portion 42. The third extending portion 42, the first elastic soldering portion 431, the second elastic soldering portion 432 and the third abutting region 1221 collectively abut against the third solder 53. The second soldering arm 44 includes a third elastic soldering portion 441 and a fourth elastic soldering portion 442 bending and extending from the third elastic soldering portion 441. The third elastic soldering portion 441 bends and extends from another side edge of the third extending portion 42. The second elastic soldering portion 432 and the fourth elastic soldering portion 442 extend toward each other. The third extending portion 42, the third elastic soldering portion 441, the fourth elastic soldering portion 442 and the fourth abutting region 1222 collectively abut against the fourth solder 54.

The first terminal 2, the second terminal 3 and the third terminal 4 are arranged in a row in the left-right direction. The first soldering arm 43 and the second abutting arm 33 are adjacent to each other in the left-right direction, and directions of lateral components of the third acting force F3 and the second acting force F2 in the left-right direction are opposite to each other. Specifically, in the left-right direction, the direction of the lateral component of the third acting force F3 is leftward, and the direction of the lateral component of the second acting force F2 is rightward. It should be noted that the first terminal 2 and the second terminal 3 may be interchangeable. That is, the first soldering arm 43 may be adjacent to the first abutting arm 23 in the left-right direction, and directions of lateral components of the third acting force F3 and the first acting force F1 may be opposite to each other.

In sum, the electrical connector according to certain embodiments of the present invention has the following beneficial effects:

1. The first abutting region 1211 abuts against a first solder 51, and the second abutting region 1212 abuts against a second solder 52, such that one abutting portion may abut against two solders, which may reduce the provision of the abutting portion, and provide more terminals in a limited space, thus facilitating the densification trend of the connector.

The first abutting arm 23 may exert a first acting force F1 directed toward the first abutting portion 121 on the first solder 51, and the second abutting arm 33 may exert a second acting force F2 directed toward the first abutting portion 121 on the second solder 52. Because the first abutting portion 121 is located between the first abutting arm 23 and the second abutting arm 33, the first acting force F1 and the second acting force F2 will eventually act on the first abutting portion 121, and the lateral components of them along the left-right direction will be opposite to each other, thereby balancing the lateral components of the first acting force F1 and the second acting force F2 at the location of the first abutting portion 121. That is, in the left-right direction, the first acting force F1 has a lateral component in a leftward direction, the second acting force F2 has a lateral component in a rightward direction, and the two lateral components are eventually balanced at the first abutting portion. Thus, the force received by the insulating body 1 from the terminals do not concentrate in the same direction, thereby allowing the insulating body 1 not to easily warp, such that the soldering of the first terminal 2 and the second terminal 3 are more stable.

2. The first extending portion 22 passes beyond the bottom wall 12, such that the first abutting arm 23 also passes beyond the bottom wall 12. In this case, the first abutting arm 23 is located outside the corresponding accommodating slot 11, and its size is not limited by the corresponding accommodating slot 11. When the solder is mounted, the first abutting arm 23 has sufficient space for deformation, and even if the solder has a volume change due to manufacturing tolerance, it may be normally clamped by the first abutting arm 23 and the first abutting portion 121. On the other hand, the first extending portion 22, the first elastic abutting portion 231, the second elastic abutting portion 232 and the first abutting region 1211 collectively abut against the first solder 51, such that the first solder 51 may be stably clamped between the first terminal 2 and the first abutting portion 121 without easily detaching therefrom.

3. The distance between the tail end of the second elastic abutting portion 232 and the tail end of the fourth elastic abutting portion 332 is shorter than the distance between the fourth side edge 3222 and the second side edge 2222, allowing a projection of the second elastic abutting portion 232 in the front-rear direction to partially overlap with the first extending portion 22, and a projection of the fourth elastic abutting portion 332 in the front-rear direction to partially overlap with the second extending portion 32, and the widths of the terminals do not significantly change, thereby enabling more terminals to be provided in the left-right direction, thus facilitating densification of the electrical connector.

4. The first bending portion 221 stops the first solder 51 from moving upward, such that the first solder 51 may be more stably fixed on the first terminal 2. Further, when the first terminal 2 is soldered on a circuit board, the first solder 51 melts and fills in the space between the first bending portion 221 and the first straight portion 222, and the signal may be transmitted to the circuit board through a path formed by the solder, without passing the first bending portion 221 with a longer path, thereby reducing the distance of the transmission of the signal in the first terminal 2, and improving high frequency performance.

5. The first protruding portion 211 and the second protruding portion 311 respectively abut against the slot walls of the corresponding accommodating slots 11, such that the first terminal 2 and the second terminal 3 may be fixed in the corresponding accommodating slots 11. However, the first protruding portion 211 and the second protruding portion 311 are close to each other, which results in the coupling strength between the first terminal 2 and the second terminal 3 to become higher, and there may be an insertion loss drop in the high frequency band. The distance between the first extending portion 22 and the second extending portion 32 is greater than the distance between the first protruding portion 211 and the second protruding portion 311, which may reduce the coupling strength between the first terminal 2 and the second terminal 3, thus reducing the insertion loss drop in the high frequency band.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the 10 appended claims rather than the foregoing description and the exemplary embodiments described therein.

What is claimed is:

1. An electrical connector, comprising:
an insulating body, comprising a bottom wall, wherein the bottom wall has a first abutting portion, and the first abutting portion is provided with a first abutting region and a second abutting region opposite to each other in a horizontal direction;
a first terminal, accommodated in the insulating body along a vertical direction, wherein the first terminal has a first abutting arm; and
a second terminal, accommodated in the insulating body along the vertical direction and adjacent to the first terminal, wherein the second terminal has a second abutting arm;
wherein the first abutting portion is located between the first abutting arm and the second abutting arm, the first abutting arm and the first abutting region clamp a first solder, the first abutting arm exerts a first acting force directed toward the first abutting portion on the first solder, the second abutting arm and the second abutting region clamp a second solder, and the second abutting arm exerts a second acting force directed toward the first abutting portion on the second solder.

2. The electrical connector according to claim 1, wherein the first terminal has a first body portion and a first extending portion formed by extending downward from the first body portion, the first extending portion passes beyond the bottom wall, the first extending portion has a first side edge close toward the second terminal and a second side edge away from the second terminal, the first abutting arm comprises a first elastic abutting portion and a second elastic abutting portion bending and extending from the first elastic abutting portion, the first elastic abutting portion bends and extends from the second side edge, and the first extending portion, the first elastic abutting portion, the second elastic abutting portion and the first abutting region collectively abut against the first solder.

3. The electrical connector according to claim 2, wherein the second elastic abutting portion extends toward a direction close toward the first abutting portion from the first elastic abutting portion, a tail end of the second elastic abutting portion has a narrow portion, the narrow portion inclines toward the first extending portion, in the vertical direction, a width of the narrow portion is less than a width of the first elastic abutting portion, and when mounting the first solder, the narrow portion abuts against and pierces the first solder.

4. The electrical connector according to claim 2, wherein the second terminal has a second body portion and a second extending portion formed by extending downward from the second body portion, the second extending portion passes beyond the bottom wall, the second extending portion has a third side edge close toward the first terminal and a fourth side edge away from the first terminal, the second abutting arm comprises a third elastic abutting portion and a fourth elastic abutting portion bending and extending from the third elastic abutting portion, the third elastic abutting portion bends and extends from the fourth side edge, the second extending portion, the third elastic abutting portion, the fourth elastic abutting portion and the second abutting region collectively abut against the second solder, the second elastic abutting portion and the fourth elastic abutting portion extend toward each other, and a distance between a tail end of the second elastic abutting portion and a tail end of the fourth elastic abutting portion is shorter than a distance between the fourth side edge and the second side edge.

5. The electrical connector according to claim 1, wherein the first terminal has a first body portion and a first extending portion formed by extending downward from the first body portion, the first abutting arm bends and extends from a side of the first extending portion, and a bottom edge of the first extending portion is provided with at least one notch.

6. The electrical connector according to claim 1, wherein the first terminal has a first body portion and a first extending portion formed by extending downward from the first body portion, the first abutting arm bends and extends from the first extending portion, the first terminal further has a groove, the groove is located between the first body portion and the first abutting arm, and the groove separates the first body portion and the first abutting arm in the vertical direction.

7. The electrical connector according to claim 1, further comprising a third terminal, wherein the third terminal has a soldering arm, the insulating body has a second abutting portion, the soldering arm and the second abutting portion clamp a third solder, the soldering arm exerts a third acting force directed toward the second abutting portion on the third solder, directions of lateral components of the third acting force and the second acting force in a left-right direction are opposite to each other, the first terminal, the second terminal and the third terminal are arranged in a row in the left-right direction, and the soldering arm and the second abutting arm are adjacent to each other in the left-right direction.

8. The electrical connector according to claim 1, wherein the first terminal has a first body portion and a first extending portion formed by extending downward from the first body portion, the first extending portion has a bending portion formed by bending backward and extending downward from the first body portion and a straight portion extending downward from the bending portion, the bending portion abuts against the first solder and stops the first solder from moving upward, the first abutting arm bends forward and extends from the straight portion, and the straight portion abuts against the first solder.

9. The electrical connector according to claim 1, wherein the first terminal has a first body portion and a first extending portion formed by extending downward from the first body portion, the first abutting arm bends and extends from the first extending portion, the first body portion comprises a first protruding portion extending toward the second terminal, and the first protruding portion abuts against the insulating body; the second terminal has a second body portion and a second extending portion formed by extending downward from the second body portion, the second abutting arm bends and extends from the second extending portion, the second body portion comprises a second protruding portion extending toward the first terminal, and the second protruding portion abuts against the insulating body; and a distance between the first extending portion and the second extending portion is greater than a distance between the first protruding portion and the second protruding portion.

10. An electrical connector, comprising:
an insulating body, comprising a bottom wall and a plurality of accommodating slots running through the bottom wall along a vertical direction, wherein the bottom wall is provided with an abutting portion, and the abutting portion is provided with a first abutting region and a second abutting region opposite to each other in a horizontal direction; and
a plurality of ground terminals, accommodated in the accommodating slots, wherein each of the ground terminals has a first soldering arm and a second soldering arm opposite to the first soldering arm;
wherein the abutting portion is located between the first soldering arm and the second soldering arm, the first soldering arm and the first abutting region clamp a first solder, and the second soldering arm and the second abutting region clamp a second solder.

11. The electrical connector according to claim 10, wherein each of the ground terminals has a body portion accommodated in a corresponding one of the accommodating slots and an extending portion extending downward from the body portion, the extending portion passes beyond the bottom wall, the first soldering arm comprises a first elastic soldering portion and a second elastic soldering portion bending and extending from the first elastic soldering portion, the first elastic soldering portion bends and extends from one side edge of the extending portion, the extending portion, the first elastic soldering portion, the second elastic soldering portion and the first abutting region collectively abut against the first solder, the second soldering arm comprises a third elastic soldering portion and a fourth elastic soldering portion bending and extending from the third elastic soldering portion, the third elastic soldering portion bends and extends from another side edge of the extending portion, the second elastic soldering portion and the fourth elastic soldering portion extend toward each other, and the extending portion, the third elastic soldering portion, the fourth elastic soldering portion and the second abutting region collectively abut against the second solder.

12. An electrical connector, comprising:
an insulating body, comprising a plurality of accommodating slots running through the insulating body along a vertical direction; and
a plurality of signal terminals, wherein each of the signal terminals comprises a body portion accommodated in a corresponding one of the accommodating slots and an extending portion formed by extending downward from the body portion, an abutting arm bends and extends from only one side of the extending portion along a horizontal direction, the abutting arm embraces a solder, and a plate surface of the abutting arm is in contact with the solder.

13. The electrical connector according to claim 12, wherein a projection of the solder along the vertical direction has more than one-half of a region being enclosed by the abutting arm.

14. The electrical connector according to claim 12, wherein the insulating body comprises a plurality of abutting portions, and two opposite sides of each of the abutting portions abut against two solders.

15. The electrical connector according to claim 12, wherein one of a left side and a right side of the body portion has a short protruding portion and the other of the left side and the right side of the body portion has a long protruding portion, the short protruding portion and the long protruding portion both abut against a slot wall of the corresponding one of the accommodating slots, along a left-right direction, a length of the long protruding portion protruding from the extending portion is greater than a length of the short protruding portion protruding from the extending portion, the long protruding portion and the abutting arm are located at a same side of the extending portion, and a groove exists between the long protruding portion and the abutting arm.

16. The electrical connector according to claim 12, wherein two adjacent ones of the signal terminals form a differential signal pair, one of a left side and a right side of the body portion has a short protruding portion and the other of the left side and the right side of the body portion has a long protruding portion, the short protruding portion and the long protruding portion both abut against a slot wall of the corresponding one of the accommodating slots, along a left-right direction, a length of the long protruding portion protruding from the extending portion is greater than a length of the short protruding portion protruding from the extending portion, and short protruding portions of two signal terminals of the differential signal pair protrude toward each other.
